(19) United States
(12) Patent Application Publication
(10) Pub. No.: US 2009/0031802 A1
(43) Pub. Date: Feb. 5, 2009

(54) ROTOR ALIGNMENT SYSTEM AND METHOD

(75) Inventors: Kenneth Damon Black, Travelers Rest, SC (US); Bradley James Miller, Simpsonville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/833,351

(22) Filed: Aug. 3, 2007

(51) Int. Cl. G01M 1/02

(52) U.S. Cl. 73/470

(57) ABSTRACT

Disclosed herein is a rotor to stator alignment method. The alignment method includes, positioning a plurality of eccentric rings between the rotor and a stator, and rotating at least one of the plurality of eccentric rings relative to the stator thereby reducing eccentricity of the rotor with the stator.

### BACKGROUND OF THE INVENTION

Rotating machines such as gas turbine engines, for example, have portions commonly referred to as rotors that rotate relative to stationary portions commonly referred to as stators. Since the rotor is rotating and the stator is stationary there are clearance dimensions between the rotor and the stator that must be maintained to prevent impacts between the rotor and the stator. Additionally, the clearances are often bridged by electromagnetic fields that are used by the machine to convert energy from one form to another such as from mechanical energy to electrical energy as in the case of a generator, for example. Dimensions of the clearance often affect the efficiency of such machines. As such it may be desirable to maintain the dimensions of the clearances within specific ranges.

The rotors and stators of rotating machines, however, are often constructed from several components that are assembled by a variety of common processes such as welding, bolting, and adhesive bonding to name a few. The final dimensions of the rotor and the stator that define the clearances therebetween may, therefore, vary more than is desirable. Some of such variation in the clearance may also be due to a lack of concentricity between the rotor and the stator. Such a variation in clearance is commonly referred to as eccentricity. As such, methods and systems to reduce or eliminate eccentricity, after a machine is assembled, may be desirable in industries that utilize rotating machines.

### BRIEF DESCRIPTION OF THE INVENTION

Disclosed herein is a rotor to stator alignment method. The alignment method includes, positioning a plurality of eccentric rings between the rotor and a stator, and rotating at least one of the plurality of eccentric rings relative to the stator thereby reducing eccentricity of the rotor with the stator.

Further disclosed herein is a rotor to stator alignment system. The system includes, a rotor, a stator receptive of the rotor, and a plurality of eccentric rings positioned between the rotor and the stator, each of the plurality of eccentric rings having an inner bore that is eccentric with an outer surface thereof, the plurality of eccentric rings being nestable and rotatable relative to one another.

### BRIEF DESCRIPTION OF THE DRAWINGS

The following descriptions should not be considered limiting in any way. With reference to the accompanying drawings, like elements are numbered alike:

FIG. 1 depicts an elevation view of a gas turbine engine with a rotor superimposed over the engine to show relative positioning therein;

FIG. 2 depicts a partial perspective view of an end of the gas turbine engine of FIG. 1 showing the eccentric rings disclosed herein with the retaining plate omitted for clarity;

FIG. 3 depicts a partial cross sectional view of the gas turbine engine of FIG. 1 showing a cross section of the eccentric rings disclosed herein;

FIG. 4 depicts a partial end view of the eccentric rings disclosed herein in a neutral offsetting configuration;

FIG. 5 depicts a partial end view of the eccentric rings disclosed herein in a rotor leftward shifting configuration;

FIG. 6 depicts a partial end view of the eccentric rings disclosed herein in a rotor upward shifting configuration;

FIG. 7 depicts a partial end view of the eccentric rings disclosed herein in a rotor rightward shifting configuration; and

FIG. 8 depicts a partial end view of the eccentric rings disclosed herein in a rotor downward shifting configuration.

### DETAILED DESCRIPTION OF THE INVENTION

A detailed description of one or more embodiments of the disclosed apparatus and method are presented herein by way of exemplification and not limitation with reference to the Figures.

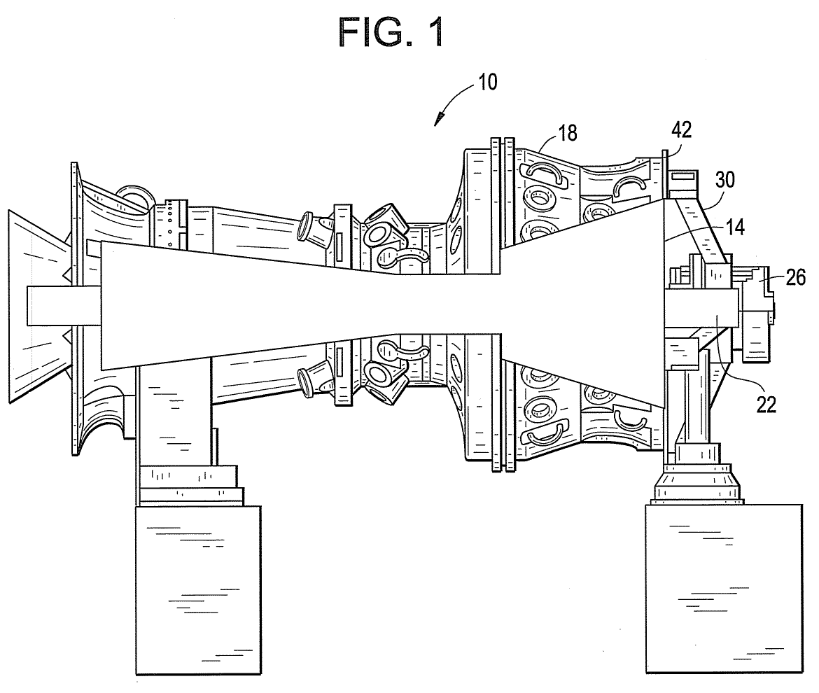

Referring to FIG. 1, a rotating machine 10, depicted herein as a gas turbine engine, is illustrated. Alternate embodiments of such rotating machines include generators, motors and alternators, for example. The engine of FIG. 1 has a rotor 14 shown superimposed over the engine 10 to reveal relative positioning of the rotor 14 within the engine 10. In addition to the rotor 14 and other things the engine 10 has a stator 18. The rotor 14 rotates within the stationary stator 18, often at high rotational speeds. It is important to maintain clearance between components (not shown) of the rotor 14 and components (not shown) of the stator 18 to prevent contact therebetween, which, if allowed, could result in potential damage and possible malfunction of the engine 10. At the same time, in order to achieve high efficiencies of the engine 10 it is desirable to keep these same clearances to a minimum. If the rotor 14, however, is located eccentric to the stator 18, the clearances at a first point may be less than desirable while, simultaneously, the clearances 180 degrees from the first point about an axis of the machine may be greater than desirable. Embodiments disclosed herein permit such eccentricities between the rotor 14 and the stator 18 to be reduced or eliminated with minimal time and effort.

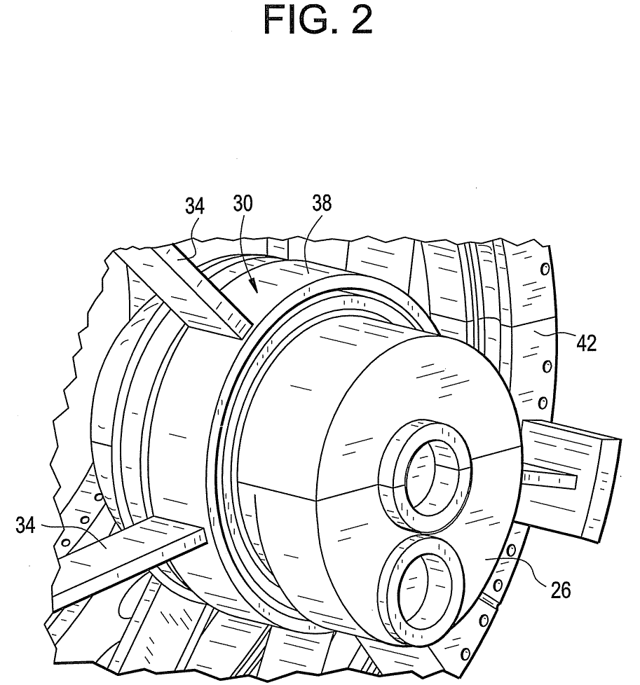

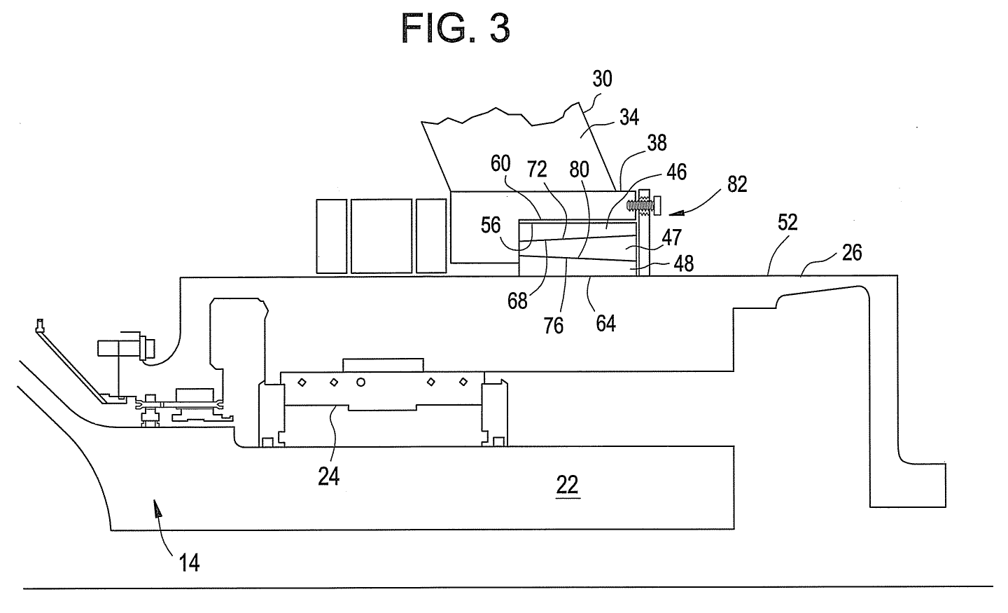

Referring still to FIG. 1, the rotor 14 includes a shaft 22 about which the rotor 14 rotates. A plurality of bearings 24 (FIG. 3) positioned at various points along the rotor 14 rotationally support and position the rotor 14 relative to the stator 18. Such bearings 24 may be positioned at either end of the shaft 22, for example, as well as at locations therebetween depending upon specific parameters of the particular engine 10. The bearings 24 are housed within bearing housings 26 that are structurally supported relative to the stator 18 by a support structure 30.

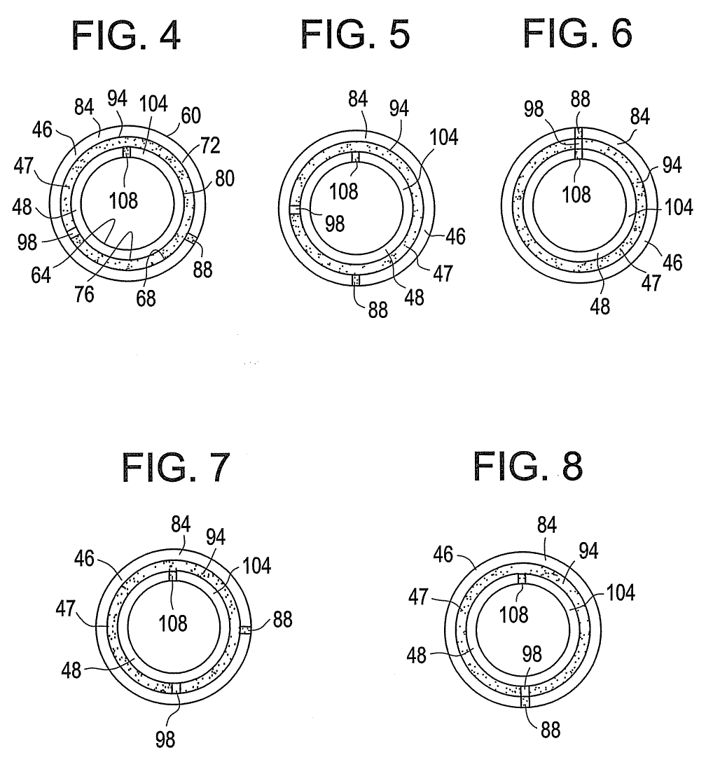

Referring to FIGS. 2 and 3, the support structure 30 includes a plurality of struts 34. The struts 34 extend radially outwardly from an inner structure 38 to an outer structure 42. The inner structure 38 has a tubular shape within which the bearing housing 26 is positioned. A plurality of eccentric rings 46, 47 and 48 (three are shown) are positioned between an outer surface 52 of the bearing housing 26 and an inner surface 56 of the inner structure 38. While three eccentric rings 46, 47 and 48 are disclosed in this embodiment, it should be understood that only two eccentric rings are needed. The eccentric rings 46, 47, 48 are used to improve alignment of the rotor 14 with the stator 18 as will be discussed in more detail with reference to FIGS. 4-8 below. The outer eccentric ring 46 has an outer surface 60 that engages with the inner surface 56 of the inner structure 38. The outer surface 60 and the inner surface 56 may be sized to minimize annular clearance therebetween. Clearance between the outer surface 60 and the inner surface 56 could contribute to an eccentricity of the rotor 14 with the stator 18. Similarly, the inner eccentric ring 48 has an inner surface 64 that is sized to fit closely with the outer surface 52 of the bearing housing 26. The inner surface 64 and the outer surface 52 may also be sized to minimize annular clearance therebetween. Additionally, this embodiment includes two more such inner surface to outer surface interfaces that will affect the overall eccentricity of the rotor 14 with the stator 18. These interfaces are; an inner surface 68 of the outer ring 46 to an outer surface 72 of the middle ring 47, and an inner surface 76 of the middle ring 47 to an outer surface 80 of the inner ring 48.

The three eccentric rings 46, 47 and 48, therefore, result in four interfaces of inner surfaces with outer surfaces each of which will have annular clearances that will contribute to an overall eccentricity of the rotor 14 with the stator 18. One embodiment, disclosed herein to minimize or eliminate these annular clearances incorporates tapers on some or all of the interfacing surfaces. For example, the inner surface 68, as shown, has a taper that increases a radial dimension thereof at positions measured while moving axially to the right (as depicted in FIG. 3). Similarly, the outer surface 72 has a complementary taper to that of the inner surface 68. These complementary tapers allow the outer ring 46 to be wedged with the middle ring 47 in response to an axial force pushing the rings 46 and 47 toward one another. Once wedged together the rings 46, 47 will, effectively, have no annular clearance therebetween, and as such, the additional interace of the surfaces 68 and 72 includes no annular clearance to add to the eccentricity of the rotor 14 with the stator 18. All four of the interfaces of inner and outer surfaces could employ this tapered arrangement even though only two of the four interfaces depicted herein have such tapers. A clamping device 82, depicted herein as a plate bolted to the inner structure 38, may be used to axially compress the rings 46, 47, 48 between the plate and an axial portion of the inner structure 38 to thereby rotationally fix them together and rotationally fix them to the stator 18. The clamping device 82 may also be loosened to facilitate rotation of the rings 46, 47, 48 during the alignment process. The clamping device 82 could further be used to rotationally fix the rings 46, 47, 48 to the bearing housing 26.

Alternate embodiments to that of the clamping device 82 shown could be employed to prevent relative rotation of the rings 46, 47, 48 once they are aligned. These may include: drilling and installing axial dowels at the ring interfaces, installing bolts and lock plates in predrilled holes on the rings 46, 47, 48, and machining scallops on axial faces of the rings 46, 47, 48 that would allow a keeper with a complementary surface to be bolted across the rings 46, 47, 48. The method used to prevent rotation of the rings 46, 47, 48 can depend upon specific design criteria of a particular application. Such design criteria may include, for example, such things as the torque required to overcome the rotation prevention mechanism, or the number of possible orientations of the rings 46, 47, 48 relative to one another and to the housings 26 or the inner structure 38. In applications wherein very fine resolution of the rotation of the rings 46, 47, 48 is desired, a mechanism that provides for an infinite number of possible orientations, such as is possible with frictional engagement between engaging frustoconical surfaces 68, 72, 76 and 80, may be employed with the clamping device 82.

Referring to FIG. 4, even though annular clearances at interfaces between the eccentric rings 46, 47, 48 may be eliminated, as described above other factors can contribute and cause eccentricity of the rotor 14 with the stator 18. For example, the tolerances and build variations of the components that make up the rotor 14 and the stator 18 can result in such undesirable eccentricity. The eccentric rings 46, 47, 48 are employed, therefore, to minimize or eliminate such eccentricity. Although three rings 46, 47, 48 are disclosed herein, alternate embodiments could use two rings or more than three rings. The inner surfaces 64, 68, 76 are made to be eccentric with the respective outer surfaces 80, 60, 72 of each respective ring 48, 46, 47. Specifically, outer ring 46 is eccentric such that a wall 84 defined by the outer surface 60 and the inner surface 64 has a smallest radial dimension 88 at a particular circumferential location thereof. Similarly, the middle ring 47 is eccentric such that a wall 94 defined by the outer surface 72 and the inner surface 76 has a smallest radial dimension 98 at a particular circumferential location thereof. And finally, the inner ring 48 is eccentric such that a wall 104 defined by the outer surface 80 and the inner surface 64 has a smallest radial dimension 108 at a particular circumferential location thereof.

The three rings 46, 47, 48 are nested together with the outer ring 46 positioned radially outwardly of the middle ring 47 that is positioned radially outwardly of the inner ring 48. Each of the rings 46, 47, 48 is rotatable such that the smallest radial dimension 88, 98, 108 of each ring 46, 47, 48 can be positioned independently of the relative orientation of the other smallest radial dimensions 88, 98, 108 of the two remaining rings 46, 47, 48. An operator can, therefore, negate an eccentric offset created by the rings 46, 47, 48 themselves by; first, building the rings 46, 47, 48 such that an eccentricity that could be created by each of the three rings 46, 47, 48 individually are all equal, and second, by distributing each of the smallest radial dimensions 88, 98, 108 as far apart angularly as possible from one another. Such an angular distribution for the engine 10 with the number of eccentric rings being three is 120 degrees apart. The embodiment of the engine 10, having three eccentric rings 46, 47, 48, therefore, can have the eccentricity of the three rings 46, 47, 48 themselves negated by the 120 degree angular distribution just described as is shown in FIG. 4. Such a configuration may be desirable if the engine 10 as built is concentric and as such does not require any adjustment to improve the eccentricity of the rotor 14 with the stator 18.

Referring to FIG. 5, an operator, after measuring an amount of eccentricity of the rotor 14 to the stator 18 of the engine 10, can determine an angular orientation in which to locate the three smallest radial dimensions 88, 98, 108 in order to reduce, or eliminate, the measured eccentricity. The angular orientation of the smallest radial dimensions 88, 98, 108 in FIG. 5, for example, would offset the rotor 14 to the left (as pictured) while not offsetting the rotor at all in the vertical direction. This is accomplished by orienting the smallest radial dimensions 88 and 108 at a 180-degree angle from each other, thereby negating the offset of each with the offset of the other. In this case, the offset of the third ring, the middle ring 47, singularly determines the complete offset of the rotor 14, which is in the leftward direction as stated above.

Referring to FIG. 6, an alternate offset configuration, one in which the three rings 46, 47, 48 combine to offset the rotor 14 in the vertically upward direction is illustrated. All three rings 46, 47, 48 have their smallest radial dimensions 88, 98, 108 oriented at the top most orientation. As such, the rings 46, 47, 48 contribute all of their offsetting eccentricity to moving the rotor 14 upward relative to the stator 18.

Referring to FIG. 7, an alternate offset configuration, one in which the three rings 46, 47, 48 combine to offset the rotor 14 in a horizontal direction only to the right is illustrated. Similar to the configuration shown in FIG. 5 the offsets of rings 47 and 48 are in opposite directions to one another and as such negate the offsetting effect of each other leaving the third ring 46 to determine the complete offset attributable to the set of rings 46, 47, 48. In this case, since the third ring 46 is oriented with its smallest radial dimension 88 to the right the system as shown offsets the rotor 14 to the right.

Referring to FIG. 8, an alternate offset configuration, one in which the three rings 46, 47, 48 combine to offset the rotor 14 in a vertical direction only is illustrated. In this embodiment the offset effect of one of the two rings 46 or 47 is negated by the offset effect of the third ring 48 that is positioned with its smallest radial dimension 108, 180 degrees opposite to that of the smallest radial dimensions 88, 98 of the two rings 46 and 47. Since the offset effect of only one of the two rings 46 or 47 is negated by the ring 48 the effect of the other of the two rings 46 or 47, is still in effect and as such offsets the rotor 14 in a vertically downward direction.

Embodiments disclosed herein may provide a means for which field alignment between the rotor 14 and the stator 18 can be adjusted without additional machining, replacement, or addition of hardware such as shims, for example. Disclosed embodiments also provide alignment capability when there is limited access to inner support structures. Such capability may reduce downtime during adjustments and during initial build by simplifying the alignment process. Additionally, disclosed embodiments allow for independent adjustment in horizontal and vertical directions utilizing a single mechanism.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A rotor to stator alignment method, comprising:
positioning a plurality of eccentric rings between the rotor and a stator; and
rotating at least one of the plurality of eccentric rings relative to the stator thereby reducing eccentricity of the rotor with the stator.

2. The rotor to stator alignment method of claim 1, further comprising rotationally fixing the plurality of eccentric rings to one another.

3. The rotor to stator alignment method of claim 1, further comprising reducing annular clearance between the plurality of eccentric rings by wedgably engaging the plurality of eccentric rings together.

4. The rotor to stator alignment method of claim 1, further comprising axially wedging the plurality of eccentric rings to one another to rotationally fix the plurality of eccentric rings together.

5. The rotor to stator alignment method of claim 1, further comprising pinning the plurality of eccentric rings together to rotationally fix the plurality of eccentric rings together.

6. The rotor to stator alignment method of claim 1, further comprising frictionally engaging the plurality of eccentric rings together to rotationally fix the plurality of eccentric rings together.

7. The rotor to stator alignment method of claim 1, further comprising rotationally fixing the plurality of eccentric rings to the stator.

8. The rotor to stator alignment method of claim 1, wherein the rotating of the at least one of the plurality of eccentric rings includes rotating at least two of the plurality of eccentric rings thereby reducing vertical eccentricity of the rotor with the stator independently of reducing horizontal eccentricity of the rotor with the stator.

9. The rotor to stator alignment method of claim 1, further comprising:
positioning at least a second plurality of eccentric rings between the rotor and the stator; and
rotating at least one of the second plurality of eccentric rings relative to the stator thereby reducing eccentricity of the rotor with the stator.

10. A rotor to stator alignment system, comprising:
a rotor;
a stator receptive of the rotor; and
a plurality of eccentric rings positioned between the rotor and the stator, each of the plurality of eccentric rings having an inner bore that is eccentric with an outer surface thereof, the plurality of eccentric rings being nestable and rotatable relative to one another.

11. The rotor to stator alignment system of claim 10, further comprising at least one bearing positioned between the rotor and the plurality of eccentric rings.

12. The rotor to stator alignment system of claim 11, wherein the plurality of eccentric rings are positioned between a housing of the at least one bearing and the stator.

13. The rotor to stator alignment system of claim 12, wherein the plurality of eccentric rings are rotationally fixable relative to the housing.

14. The rotor to stator alignment system of claim 10, wherein the plurality of eccentric rings are rotationally fixable relative to one another.

15. The rotor to stator alignment system of claim 10, wherein the plurality of eccentric rings are rotationally fixable relative to the stator.

16. The rotor to stator alignment system of claim 10, wherein at least one of the inner bore and the outer surface are cylindrical.

17. The rotor to stator alignment system of claim 10, wherein at least one of the inner bore and the outer surface are axially tapered.

18. The rotor to stator alignment system of claim 10, wherein at least one of the inner bore and the outer surface are frustoconical.

19. The rotor to stator alignment system of claim 10, wherein at least one inner bore is axially wedgable with at least one outer surface to thereby eliminate annular clearance therebetween.

20. The rotor to stator alignment system of claim 10, wherein the plurality of eccentric rings allow for independent adjustment in at least two orthogonal planes.
